(19) United States
(12) Patent Application Publication
(10) Pub. No.: US 2026/0097419 A1
(43) Pub. Date: Apr. 9, 2026

(54) SELECTOR MACHINE

(71) Applicant: 3U VISION SRL, Imola (IT)

(72) Inventor: Andrea UZZO, Imola (IT)

(21) Appl. No.: 19/346,597

(22) Filed: Oct. 1, 2025

(30) Foreign Application Priority Data
Oct. 3, 2024 (IT) 202024000003981

(51) Int. Cl. B07C 5/342

(52) U.S. Cl. CPC B07C 5/342

(57) ABSTRACT

Selector machine, which includes a conveyance system which defines an advancement path for a loose product formed by multiple solid elements, advances such loose product via falling in an analysis section of the advancement path. Moreover, the selector machine includes an optical detection system provided with optical emitters arranged for emitting towards the analysis section electromagnetic radiation, and with an optical sensor arranged for intercepting electromagnetic radiation coming from the loose product irradiated by the optical emitters. The optical emitters have multiple infrared LEDs which emit infrared radiation in corresponding different spectral infrared bands, so that the sum of such spectral bands forms a continuous spectral infrared band. The optical sensor includes a hyperspectral camera, which has a spectral range that covers the aforesaid continuous spectral infrared band, so as to be able to generate hyperspectral images in the infrared of the loose product.

### FIELD OF APPLICATION

The present finding regards a selector machine.

The present selector machine is inserted in the field of production of machines for sorting products, which are advantageously employed for identifying, within a loose product, given solid elements to be separated.

Advantageously, the present selector machine is adapted to operate on small-size loose products, in particular smaller than about 15 mm (even up to 1-2 mm).

The present selector machine is, in particular, intended to be employed in the agricultural industry, for example for separating dried fruit from the corresponding shells before packaging, in the industry of recovery and recycling of waste, for example for separating waste attained with plastic materials that are different from each other, or in any other field in which it is necessary to separate solid elements from each other in a loose product based in particular on their external appearance and/or on their chemical-physical properties.

### STATE OF THE ART

Known on the market are selector machines, of automated type, which are employed for separating, within a product constituted by multiple objects, given objects to be selected or discarded.

As is known, the selector machines are generally provided with a conveyance system on which a flow of a loose product is advanced, comprising at its interior multiple solid elements which must be distinct and separated. Such loose product can, for example, comprise dried fruit (such as hazelnuts, almonds, walnuts, which must be separated from their shells before being packaged) or cereals, or it can comprise waste attained from different material (e.g. plastic), which must be separated from each other in order to allow a correct sorting or recycling thereof.

For example, the conveyance system comprises one or more hoppers through which the product is made to slide within the machine itself on a system of slides and up to collection boxes.

The selector machines also comprise an optical detection system arranged in order to acquire and analyze images of the flow of loose product, so as to distinguish, in the loose product, the solid elements to be separated or discarded.

Such detection system is adapted to send command signals, based on the information obtained from the acquired images, to an expulsion system (such as solenoid valves) actuatable for removing the selected solid elements from the loose product, for example through emission of jets of compressed air.

More in detail, in order to distinguish and separate from the loose product the solid elements having similar color in the visible light spectrum, the optical detection system of the selector machines of known type comprise color cameras adapted to detect images of the product in the visible spectrum, and infrared cameras, adapted to detect chemical-physical characteristics of the loose product which are not detectable or easily detectable by means of the analysis of the actual colors of the product itself.

For such purpose, the selector machines are provided with optical emitters which emit white light (for detecting the actual colors by means of the color cameras) and further optical emitters which emit infrared light (for detecting infrared images by means of the infrared cameras).

In particular, known is the use of multispectral cameras, both color and infrared, for detecting the images of the products. Nevertheless, such cameras, do not always provide a sufficiently precise information quality (in particular in terms of spectral resolution in the spectral bands of interest).

In addition, also the optical emitters, in particular infrared, are not able to illuminate the products with the entire spectral band of interest.

Also known is the use of hyperspectral cameras, which allow providing a spectral resolution much higher than the hyperspectral cameras (being able to distinguish also more than one hundred spectral bands placed adjacent to each other), and therefore allow analyzing the products substantially in the entire spectral band of interest.

Nevertheless, even if the hyperspectral cameras allow executing the aforesaid analysis, it is necessary that the products be illuminated with radiation that has a substantially continuous spectrum in the bands where such cameras operate. Indeed, if the lights with which the products are irradiated had discontinuities in their spectral band, the hyperspectral camera (even if it has a very high spectral resolution) would not be able to generate the images for the wavelengths that fall within the aforesaid discontinuities of the emitted lights.

In order to provide such illumination with continuous band, halogen or incandescent lamps are employed, which are by now hard to find and very costly, or LEDs with wide spectrum are employed, which are also quite costly.

### Presentation of the Invention

In this situation, the problem underlying the present finding is therefore that of eliminating the problems of the abovementioned prior art, by providing a selector machine, which allows executing a precise spectral analysis of the products (in particular in the infrared spectrum) and, simultaneously, is inexpensive to attain.

A further object of the present finding is that of providing a selector machine which operates in an efficient manner.

A further object of the present finding is that of providing a selector machine, which is entirely reliable in operation.

### BRIEF DESCRIPTION OF THE DRAWINGS

The technical characteristics of the present finding, according to the aforesaid objects, and the advantages thereof will be more evident in the following detailed description, made with reference to the enclosed drawings, which represent several merely exemplifying and non-limiting embodiments of the invention, in which:

FIG. 1 shows a perspective view of a selector machine according to the present finding;

FIG. 2 shows a side section schematic view of the selector machine, object of the present finding;

FIG. 3 shows a schematized representation of the optical emitters, in accordance with a first embodiment of the present selector machine;

FIG. 4 shows a detail of the optical emitters of FIG. 3;

FIG. 5 shows a schematized representation of the optical emitters, in accordance with a second embodiment of the present selector machine;

FIG. 6 shows a detail of the optical emitters of FIG. 5;

FIG. 7 shows the spectral intensity of the single spectral bands of infrared LEDs of the optical emitters;

FIG. 8 shows the spectral intensity of a continuous spectral infrared band obtained as resultant of the single spectral bands of FIG. 7.

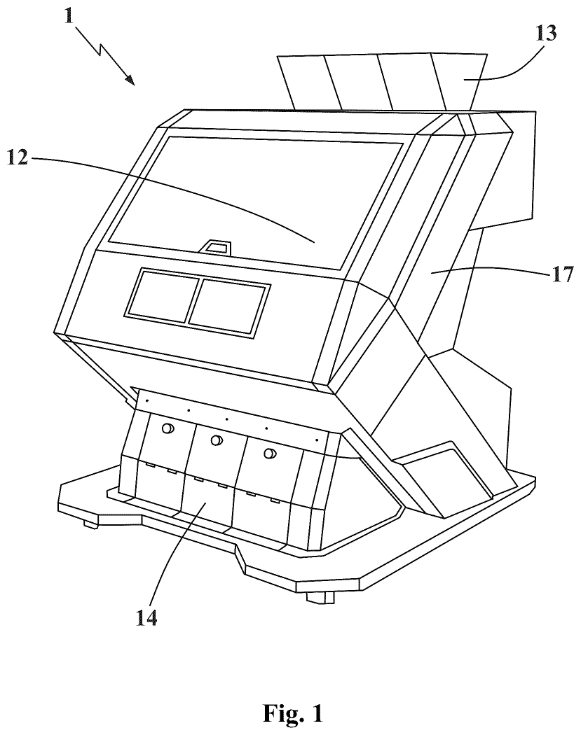

### DETAILED DESCRIPTION OF A PREFERRED EMBODIMENT

With reference to the enclosed figures, reference number 1 indicates a selector machine according to the present finding.

Advantageously, the present selector machine 1 is intended to be employed, in different application contexts, for selecting given elements in a product constituted by a set of solid elements, in particular with very similar shape and/or color.

More in detail, the present selector machine 1 is intended to be employed in the food industry, in particular so as to identify, in a loose product (in particular granular), such as for example dried fruit (hazelnuts, walnuts, almonds), seeds, cereals or the like, elements which must be discarded before the packaging of the product, which can for example be shells of dried fruit, discards of food product processing or other non-edible foreign bodies.

In addition, the present selector machine 1 can be employed in the industry for waste recovery, in particular in order to identify elements of given materials (e.g. different types of plastic) in order to be correctly disposed of or recycled.

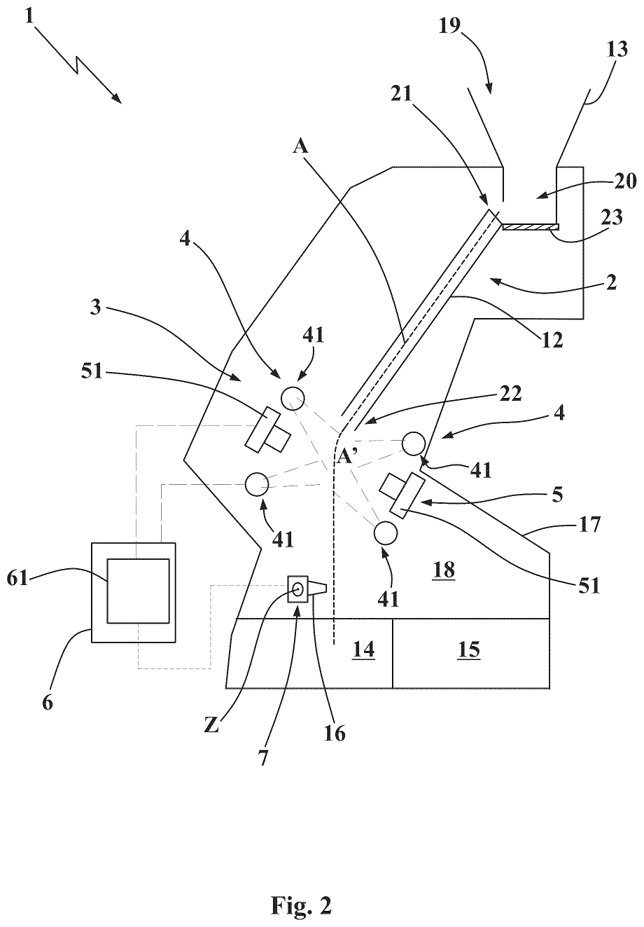

With reference to the scheme of FIG. 2, the selector machine 1 comprises a conveyance system 2, which defines an advancement path A, along which it is susceptible of advancing at least one loose product comprising multiple solid elements to be selected.

In addition, such conveyance system 2 is arranged for advancing the loose product via falling at least in an analysis section A′ of the advancement path A.

More in detail, the present selector machine 1 comprises a support frame 17, which carries, mounted thereon, the conveyance system 2 and internally defines an operative volume 18 at least partially crossed by the advancement path A.

Advantageously, the conveyance system 2 comprises at least one hopper 13, which is placed upstream of the advancement path A and is adapted to provide the loose product on the advancement path A.

In particular, the hopper 13 is mounted on the support frame 17 and is provided with an upper open end 19, through which the loose product is advantageously provided to the present selector machine 1, and a lower end 20 communicating with the operative volume 18, so as to provide the aforesaid loose product on the advancement path A.

In addition, the conveyance system 2 advantageously comprises at least one slide 12 placed along the advancement path A upstream of the analysis section A′ and, preferably, placed within the operative volume 18 defined by the support frame 17 downstream of the hopper 13.

Advantageously, the aforesaid slide 12 it is susceptible of being crossed by loose product preferably unloading the loose product via falling along the analysis section A′.

In particular, the slide 12 is extended along an extension direction thereof, which is preferably substantially rectilinear and tilted with respect to a vertical direction, so as to define a section, also rectilinear, of the advancement path A, between a first end 21 operatively connected to the lower end of the hopper 13 and an opposite second end 22, starting from which the analysis section A′ is extended in the air.

Preferably, in addition, the conveyance system 2 comprises a vibrating feeder 23 interposed between hopper 13 and slide 12 (in particular between lower end 20 of the hopper 13 and first end 21 of the slide 12) and arranged for advancing the loose product from the hopper 13 itself to the slide 12, along which the loose product descends via gravity in order to be distributed and advance along the advancement path A.

The present selector machine 1 comprises an optical detection system 3, which is advantageously arranged for identifying, in the loose product that advances along the advancement path A, the solid elements to be eliminated.

The aforesaid optical detection system 3 comprises optical emitters 4, which are arranged for emitting, towards the analysis section A′ of the advancement path A, electromagnetic radiation adapted to hit the loose product.

In addition, the optical detection system 3 comprises at least one optical sensor 5, which is directed towards the advancement path A, in particular towards the analysis section A′ of the advancement path A itself. Such optical sensor 5 is arranged for intercepting electromagnetic radiation coming from the loose product irradiated by the optical emitters 4 and for transducing the aforesaid electromagnetic radiation into corresponding measurement signals. More in detail, the optical detection system 3 is placed along the advancement path A, in particular below the slide 12 of the conveyance system 2, so as to detect the loose product in free fall from the slide 12 itself along the analysis section A′ with the solid elements to be selected spaced from each other.

In addition, the optical detection system 3 is preferably placed in the operative volume 18 defined inside the support frame 17, in a manner such that, in particular, the support frame 17 itself screens the optical detection system 3 from the light coming from the outside environment, which otherwise could interfere with the electromagnetic radiation emitted by the optical emitters 4 and by the electromagnetic radiation coming from the irradiated loose product which must be detected by the optical sensor 5.

The selector machine 1 also comprises an electronic control unit 6, which is operatively connected to the optical sensor 5 in order to receive the measurement signals and is arranged for emitting command signals, and an expulsion system 7, which is connected to the electronic control unit 6 in order to receive such command signals.

The aforesaid command signals are adapted to command the expulsion system 7 itself to eliminate, from the advancement path A, given solid elements of the loose product.

Preferably, the expulsion system 7 comprises multiple nozzles 16 directed towards the analysis section A′ of the advancement path A and arranged for emitting a jet of compressed air in order to eliminate the solid elements from the advancement path A, based on the measurement signals provided by the optical detection system 3.

In particular, the nozzles 16 of the expulsion system 7 are placed side-by-side each other along a positioning direction Z transverse (preferably orthogonal) to the advancement path A (e.g. horizontal) and preferably substantially parallel to the lying plane on which slide 12 of the conveyance system 2 is extended.

Advantageously, the nozzles 16 are placed below the optical detection system 3 and are actuatable, based on the command signals sent by the electronic control unit 6, each by means of a corresponding solenoid valve, to emit a jet of compressed air towards the flow of loose product in free fall along the analysis section A′ of the advancement path A.

In particular, each nozzle 16 is operatively associated with a given point of the analysis section A′ (for example according to a given position grid), in a manner such that the actuation of each nozzle 16 generates a flow of air that hits the elements which pass at such given point of the analysis section A′.

In this manner, the solid elements that must be separated from the rest of the loose product are hit by the jet of compressed air emitted by one of the nozzles 16 of the expulsion system 7 and are effectively deflected from the advancement path A while they are found in the situation of free fall from the slide 12 along the analysis section A′.

Advantageously, the conveyance system 2 also comprises at least one first collection space 14, susceptible of receiving the loose product coming from the advancement path A, and at least one second collection space 15, susceptible of receiving the solid elements eliminated from the advancement path A by the expulsion system 7.

More in detail, the first collection space 14 is placed below the slide 12 of the conveyance system 2 substantially at the end of the analysis section A′, such that the aforesaid first collection space 14 receives the loose product in free fall from the slide 12 that was not removed from the advancement path A by means of the expulsion system 7.

In addition, the second collection space 15 is placed adjacent to the first collection space 14, in a manner such that the aforesaid second collection space 15 receives the solid elements which were hit by the jet of compressed air emitted by one of the nozzles 16 of the expulsion system 7 and hence deflected from the advancement path A.

Suitably, the present selector machine 1 can comprise multiple advancement paths A (defined for example by corresponding hoppers 13, vibrating feeders and slides 12) with corresponding first and second collection spaces 14, 15, so as to select multiple loose products, even simultaneously.

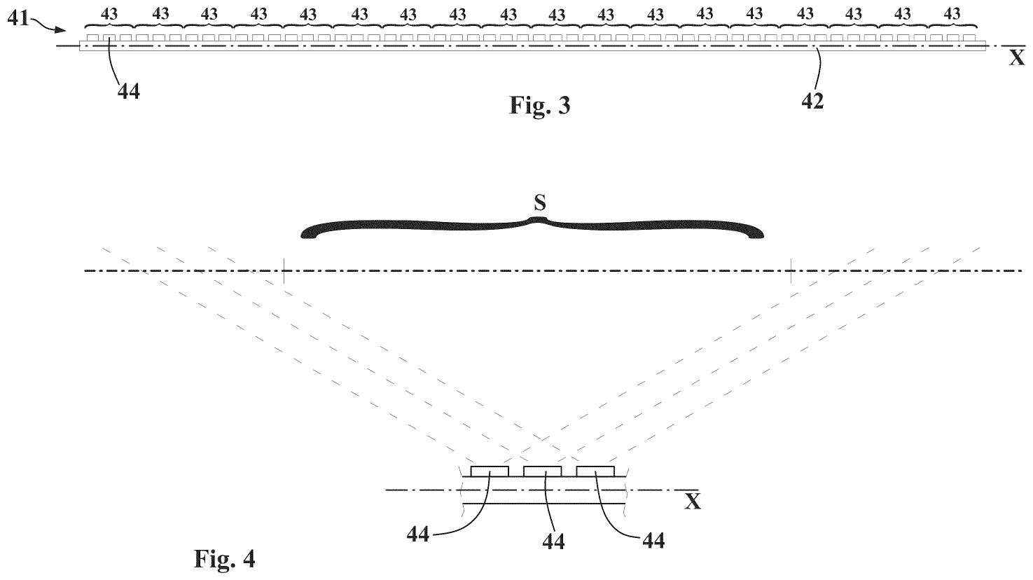

With reference to the schemes of FIGS. 3-6, the optical emitters 4 comprise at least one row 41 of LEDs placed aligned along an alignment direction X orthogonal to the advancement path A and, more in detail, horizontal. The aforesaid LEDs are arranged for emitting the electromagnetic radiation towards the analysis section A′ so as to irradiate the loose product.

Advantageously, the row 41 of LEDs is placed on a corresponding support bar 42, which is extended along the alignment direction X and is preferably mounted on the support frame 17, in particular within the operative volume 18 of the selector machine 1.

Advantageously, as illustrated in the example of FIG. 2, the optical emitters 4 comprise multiple rows 41 of LEDs, which in particular are placed on opposite sides of the advancement path A (for example on the front and back part of analysis section A′), and/or at different heights (for example for irradiating the analysis section A′ from above or below). Such rows 41 of LEDs are mounted on corresponding support bars 42.

Optionally, the optical emitters 4 can comprise optical means (such as lenses and mirrors) adapted to suitably condition the beams of electromagnetic radiation emitted by the LEDs. For example, the optical emitters 4 can comprise a reflecting mirror (with section of parabolic or elliptical shape) placed on the support bar 42 and positioned so as to intercept the electromagnetic radiation emitted by the LEDs and reflect them towards the analysis section A′ of the advancement path A, for example in order to concentrate them at a focus line parallel to the alignment direction X.

The optical emitters 4 are arranged for emitting infrared radiation and, advantageously, also radiation in the visible spectrum (as discussed in detail hereinbelow).

The infrared radiation is adapted to irradiate the loose product that passes through the analysis section A′ of the advancement path A such that, by means of the optical sensor 5, it is possible to acquire corresponding infrared images of such loose product.

In detail, the aforesaid infrared radiation has spectrum that is extended at least in a given continuous spectral infrared band. Such spectral infrared band is continuous in the sense that it does not have discontinuities (gaps) from its lower limit to its upper limit.

Advantageously, the continuous spectral infrared band is at least partially extended within the SWIR spectrum. In particular, the SWIR spectrum is intended comprised between 900 nm and 3000 nm.

Preferably, the continuous spectral infrared band is at least partially extended in the interval from 900 nm to 1800 nm.

Advantageously, the continuous spectral infrared band is at least partially extended within the NIR spectrum. In particular, the NIR spectrum is intended comprised between 700 nm and 900 nm.

Advantageously, the continuous spectral infrared band is at least partially extended in the interval from 700 nm to 3000 nm.

Advantageously, the continuous spectral infrared band has length of at least 300 nm, preferably of at least 600 nm.

For example, the continuous spectral infrared band is extended in a continuous manner at least from 1000 nm to 1600 nm (with a length of 600 nm).

In accordance with another embodiment, the continuous spectral infrared band is extended in a continuous manner at least from 750 nm to 1700 nm (with a length of 950 nm).

The optical emitters 4 (and specifically their LEDs) are arranged for emitting the aforesaid continuous spectral infrared band by means of the configuration described hereinbelow.

With reference to the scheme of FIG. 3, the row 41 of LEDs is organized in multiple groups 43 of LEDs, placed side-by-side along the alignment direction X, such that each group 43 comprises a corresponding section of the row 41 of LEDs.

I LEDs of each group 43 comprise multiple infrared LEDs 44 arranged for emitting infrared radiation in corresponding different spectral infrared bands.

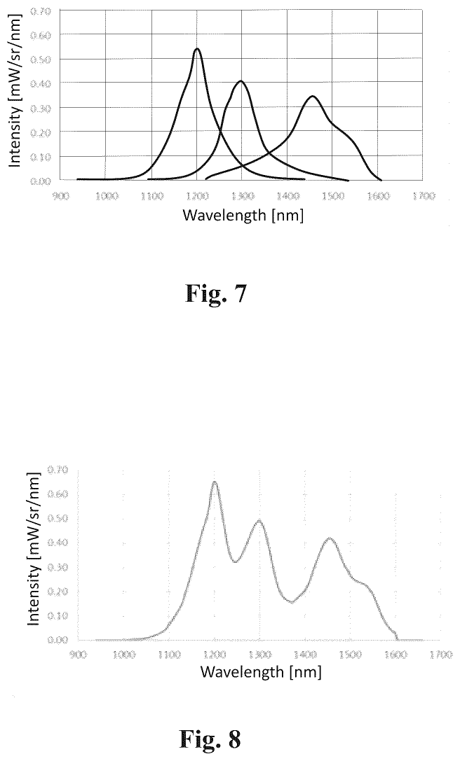

One example of the different spectral bands of the infrared LEDs of a group 43 is illustrated in FIG. 7.

The sum of the different spectral bands of the infrared LEDs 44 complete covers at least the aforesaid continuous spectral infrared band, such that, by actuating together, the infrared LEDs 44 emit a set of infrared radiation that is extended for the interval of the entire continuous spectral infrared band, without interruptions.

For such purpose, therefore, the electronic control unit 6 of the selector machine 1 is arranged for simultaneously actuating the infrared LEDs 44 of each group 43, so as to emit the aforesaid set of infrared radiation in order to obtain the continuous spectral infrared band. One example of such spectral continuous band is illustrated in FIG. 8.

In particular, the electronic control unit 6 is arranged for simultaneously actuating all the groups of LEDs together.

Advantageously, the spectral band of each infrared LED 44 is partially superimposed on the spectral band at least of the adjacent infrared LEDs 44 in the corresponding group 43, such that in the transition zone between the spectral band of one of the infrared LEDs 44 and that of the adjacent infrared LED 44 there is at least a section of superimposition between the two spectral bands, thus ensuring the absence of interruptions in the continuous spectral infrared band.

In particular, as is for example shown in FIG. 7, each spectral band has at least one peak, from which it descends with two lateral flanks, which preferably are each extended at least to the peak of the spectral band of the corresponding adjacent infrared LED 44.

The number of infrared LEDs 44 of each group 43 and the spectral bands of each of them are arrange as a function of the specific infrared analysis that the selector machine 1 must execute.

Advantageously, each group 43 of LEDs comprises at least two infrared LEDs, and preferably at least three infrared LEDs. For example, with reference to the embodiments of FIGS. 3-6, each group 43 of LEDs comprises three infrared LEDs 44.

Advantageously, with reference to FIG. 4, each group of LEDs is arranged for irradiating a corresponding sector S of the analysis section A′ parallel to the alignment direction X of the row 41 of LEDs. Thus, such sector S, preferably horizontal, is extended orthogonal to the advancement path A along which the loose product is adapted to descend.

In particular, the radiation emitted by several of the infrared LEDs 44 of a group 43 can also affect the adjacent sector S (which is illuminated by the group 43 of adjacent LEDs).

Each infrared LED 44 is arranged for emitting a radiation beam which is adapted to irradiate at least the entire corresponding sector S, being superimposed, in such sector S, on the beam of each other infrared LED 44 of the corresponding group 43.

In this manner, the sector S (and hence the loose product that crosses it) is irradiated by all the spectral bands of the infrared LEDs 44 and, thus, in such sector S, such spectral bands are superimposed, obtaining an irradiation of the sector S with the aforesaid continuous spectral infrared band.

Advantageously, the infrared LEDs 44 of each group 43 are placed at a distance from the analysis section A′ of the advancement path A, and in particular from the corresponding sector S of the latter, and are arranged for emitting a radiation beam with opening angle such that the beam of each infrared LED 44 completely irradiates the sector S associated with the corresponding group 43 of LEDs.

In addition, advantageously, the distance between the infrared LEDs 44 (along the alignment direction X) and the opening angle of the beam of each of them are such that there are no portions of the sector that are not irradiated by all the infrared LEDs 44.

According to the present finding, the optical sensor 5 of the selector machine comprises at least one hyperspectral camera 51, which has a spectral range (spectral range) that covers at least the continuous spectral infrared band generated by the infrared LEDs 44 of the optical emitters 4.

In this manner, the hyperspectral camera 51 allows the electronic control unit 6 to acquire hyperspectral images of the loose product in the analysis zone A′ irradiated by the infrared radiation. The information contained in such hyperspectral images are employed by the electronic control unit 6 in order to identify the elements of the loose product to be discarded and consequently command the expulsion system 7.

Preferably, the optical sensor 5 comprises multiple hyperspectral cameras 51, for example placed on opposite sides of the advancement path A, in particular on the front and back part of the latter as in the example of FIG. 2.

Advantageously, the hyperspectral camera 51 has the spectral range defined by multiple spectral resolution bands adjacent to each other and preferably uniformly distributed. Each hyperspectral resolution band covers a given interval of the spectral range of the hyperspectral camera (and hence a given interval of the continuous spectral infrared band of the radiation with which the elements of the loose product are irradiated). Each spectral resolution band therefore can provide information on the loose product which can be identified when the latter is irradiated by radiation in such spectral resolution band.

Advantageously, the hyperspectral camera 51 comprises multiple dozens of spectral resolution bands, in particular at least one hundred, adjacent to each other (without interruptions along the spectral range). In this manner, in particular, the hyperspectral camera 51 allows executing substantially continuous analyses of the spectral properties of the loose product.

Advantageously, the hyperspectral camera has spectral resolution smaller than or equal to 10 nm FWHM, preferably smaller than or equal to 5 nm FWHM, and still more preferably smaller than or equal to 3 nm FWHM. Such spectral resolution corresponding to the width of each spectral resolution band.

Advantageously, the electronic control unit 6 is adapted to identify the solid elements to be selected and discarded with respect to the flow of loose product (thus generating the command signals in order to actuate the expulsion system 7) based on the information acquired by the hyperspectral camera 51, relative to the loose product that passes along the analysis section A′ and which is irradiated by the infrared LEDs 44 of the optical emitters 4. Advantageously, the hyperspectral camera 51 is arranged for detecting, for each spectral resolution band of its spectral range, corresponding electromagnetic radiation coming from the irradiated loose product and generating corresponding measurement signals.

In addition, the electronic control unit 6 comprises advantageously a processing module 61, which is arranged for generating, from the measurement signals, corresponding images of the loose product.

Therefore, the image generated by each spectral resolution band provides the optical properties in the infrared of the loose product in such spectral band.

Advantageously, the electronic control unit 6 is provided with at least one thresholding software, per se of known type (and hence not discussed hereinbelow), which defines the criteria with which the electronic control unit 6 itself determines, based on the acquired measurement signals (i.e. in particular based on the images processed by the processing module 11), the solid elements to be eliminated and, consequently, the command signals to send to the expulsion system 7.

Advantageously, the images of the loose product are intended to be processed as computer data by the software of the electronic control unit 6, so as to determine the command signals to send to the expulsion system 7

In particular, the images are not necessarily intended to be shown, for example through a monitor of the selector machine 1.

Advantageously, the electronic control unit 6 comprises one or more hardware devices, preferably one or more electronic circuit boards, which, even more preferably, carry suitable processor modules installed thereon (for example, the one or more modules arranged for analyzing the measurement signals coming from the optical sensor 5) and/or operative modules (for example, the one or more modules arranged for generating the command signals as a function of the analyzed measurement signals and for sending such command signals to the expulsion system 7), in which such processor modules and/or operative modules are in particular in the form of integrated circuits (chips or micro-chips).

For example, such electronic control unit 6 can be provided with a hardware device for controlling the optical emitters 4, with a hardware device for controlling the optical sensor 5 and with a hardware device for controlling the expulsion system 7, and such hardware devices are preferably operatively connected to a same central hardware control device, in particular a PLC unit (in which, with the expression “PLC unit” it must be intended a unit of “programmable logic controller”type).

In accordance with a particular embodiment, part of the electronic control unit 6 can be integrated (at least in part) in the hyperspectral camera 51, which in this case will be implemented as smart-camera.

Advantageously, the optical emitters 4 are also arranged for emitting electromagnetic visible light radiation at least in a given spectral continuous band of the visible spectrum.

In particular, such spectral continuous band of the visible spectrum forms, with the continuous spectral infrared band, an overall continuous spectral band, i.e. a spectral band with interruptions (gaps) and which is extended for the visible spectrum and at least part of the infrared spectrum (defined by the continuous spectral infrared band).

Preferably, such overall continuous spectral band is at least partially extended in the interval from 400 nm to 1800 nm.

For example, the continuous spectral infrared band is extended in a continuous manner at least from 450 nm to 1600 nm.

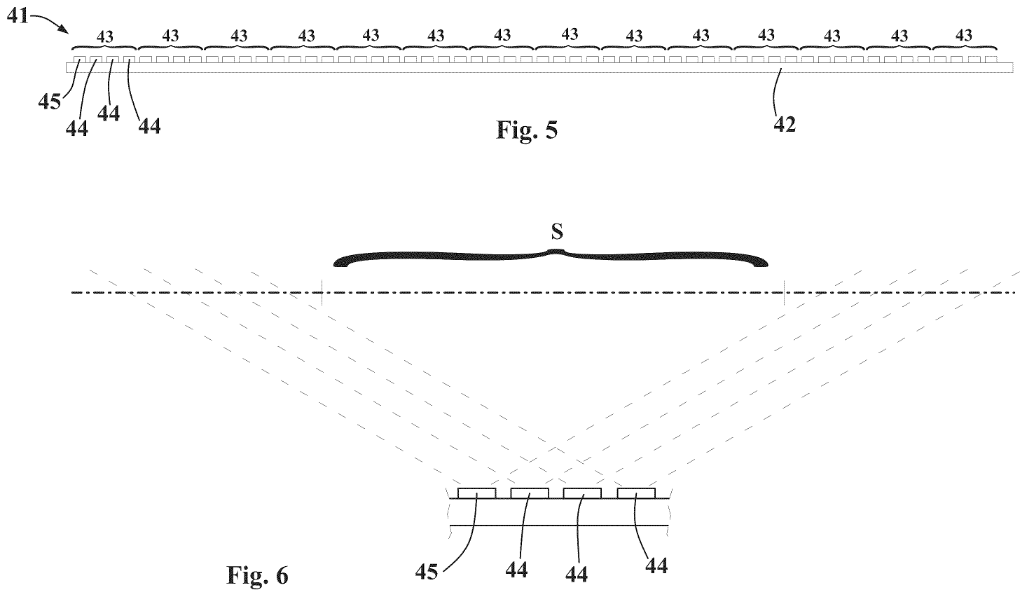

Advantageously, with reference to the embodiment illustrated in FIGS. 5 and 6, each group 43 of LEDs comprises one or more bright LEDs 45 adapted to generate the visible light radiation adapted to illuminate the loose product that crosses the analysis zone A′.

For example, each group 43 of LEDs comprises a bright LED 45 of white light. In accordance with a different embodiment, each group 43 of LEDs comprises one or more bright LEDs 45 adapted to emit radiation within a limited band of the visible spectrum, e.g. within the red, green, and/or blue bands.

Advantageously, analogous to that discussed above for the infrared LEDs 44, each light LED 45 is arranged for emitting a light beam which is adapted to irradiate at least the entire corresponding sector S of the analysis zone A′, being superimposed, in such sector S, on the beam of the infrared LEDs 44 of the corresponding group 43 (as illustrated in the example of FIG. 6).

In this manner, the sector S (and thus the product which crosses it) is irradiated by all the spectral bands of the LEDs (infrared 44 and light 45) and, hence, in such sector S, such spectral bands are superimposed, obtaining an irradiation of the sector S with the aforesaid overall continuous spectral band, thus allowing the execution of an efficient analysis, both in the visible and in the infrared spectrum.

For such purpose, the optical sensor 5 is also sensitive to the visible spectrum in order to acquire images of the loose product irradiated by the bright LEDs 45 and also allow, in particular by means of the image processing module 61, generating visible images of the elements of the loose product.

For example, the hyperspectral camera 51 has spectral range also comprising the visible spectrum in order to acquire visible images of the loose product.

In accordance with a different embodiment (not illustrated in the enclosed figures), the optical sensor 5 of the selector machine 1 comprises at least one separate color camera in order to detect the visible images of the loose product.

Advantageously, the hyperspectral camera 51 (and preferably the possible color camera) has an acquisition frequency greater than 15 kHz, so as to be able to acquire images of the elements of the loose product (which descend along the advancement path A with a speed generally equal to about 4 m/s) with a good spatial resolution, even in the case of very small elements like cereals.

For example, the hyperspectral camera is of linear scanning type (push-broom), per se of known type.

The finding thus conceived therefore attains the pre-established objects.

In particular, the arrangement of the optical emitters 4, organized in groups 43 of LEDs according to that described above, allows irradiating the loose product with a continuous spectrum (with interruption) in the spectral band (infrared) of interest, with a configuration that is simple and inexpensive to attain and that, when coupled to the hyperspectral camera 51, allows efficiently analyzing the optical characteristics of the loose product at least in the infrared.

The contents of the Italian application number 202024000003981, from which this application claims priority, are incorporated herein by reference.

1. A selector machine, comprising:
a conveyance system (2), which defines an advancement path (A) along which it is susceptible of advancing at least one loose product comprising multiple solid elements to be selected, and is arranged for advancing said loose product via falling at least in an analysis section (A′) of said advancement path (A);
an optical detection system (3) comprising:
optical emitters (4) comprising at least one row (41) of LEDs placed aligned along an alignment direction (X) orthogonal to said advancement path (A) and arranged for emitting, towards the analysis section (A′) of said advancement path (A), electromagnetic radiation adapted to hit said loose product;
an optical sensor (5) directed towards said advancement path (A) and arranged for intercepting electromagnetic radiation coming from said loose product irradiated by said optical emitters (4), and for transducing said electromagnetic radiation into corresponding measurement signals;
an electronic control unit (6) operatively connected to said optical sensor (5) to receive said measurement signals, and arranged for emitting command signals;
an expulsion system (7) operatively connected to said one electronic control unit (6) to receive said command signals, which are adapted to command said expulsion system (7) to eliminate, from said advancement path (A), given solid elements of said loose product;
wherein said optical emitters (4) are arranged for emitting infrared radiation at least in a given continuous spectral infrared band;
wherein said at least one row (41) of LEDs is organized in multiple groups (43) of LEDs, placed side-by-side along said alignment direction (X);
wherein the LEDs of each said group (43) comprise multiple infrared LEDs arranged for emitting infrared radiation in corresponding different spectral infrared bands, wherein the sum of said spectral bands completely covers at least said continuous spectral infrared band;
wherein said electronic control unit (6) is arranged for simultaneously actuating said infrared LEDs (44);
wherein said optical sensor (5) comprises at least one hyperspectral camera (51), which has a spectral range that covers at least said continuous spectral infrared band.

2. The selector machine of claim 1, wherein each said group (43) of LEDs is arranged for irradiating a corresponding sector(S) of said analysis section (A′) parallel to said alignment direction (X);
wherein each said infrared LED (44) is arranged for emitting a radiation beam which is adapted to irradiate at least the corresponding said sector(S) and, in said sector(S), it is superimposed on the radiation beam of each other said infrared LED (44) of the corresponding said group (43).

3. The selector machine of claim 1, wherein the spectral band of each said infrared LED (44) is partially superimposed on the spectral band at least of the adjacent infrared LEDs in the corresponding said group (43).

4. The selector machine of claim 1, wherein said continuous spectral infrared band is extended, at least partially, within SWIR spectrum.

5. The selector machine of claim 1, wherein said continuous spectral infrared band is extended, at least partially, in the interval from 900 nm to 1800 nm.

6. The selector machine of claim 1, wherein said continuous spectral infrared band is extended, at least partially, within NIR spectrum.

7. The selector machine of claim 6, wherein said continuous spectral infrared band is extended, at least partially, in the interval from 700 nm to 3000 nm.

8. The selector machine of claim 1, wherein said continuous spectral infrared band has length of at least 300 nm.

9. The selector machine of claim 1, wherein said at least one hyperspectral camera (51) has spectral resolution defined by multiple spectral resolution bands adjacent to each other.

10. The selector machine of claim 9, wherein the spectral range of said at least one hyperspectral camera (51) comprises multiple dozens of said spectral resolution bands.

11. The selector machine of claim 9, wherein:
said at least one hyperspectral camera (51) is arranged for generating, for each said spectral resolution band, corresponding measurement signals;
said electronic control unit (6) comprises a processing module (61), which is arranged for generating, from said measurement signals, corresponding images of said loose product.

12. The selector machine of claim 1, wherein each said group (43) of LEDs comprises at least two said infrared LEDs (44).

13. The selector machine of claim 1, wherein said optical emitters (4) are arranged for emitting electromagnetic visible light radiation at least in a given spectral continuous band of the visible spectrum, which, with said continuous spectral infrared band, forms an overall continuous spectral band;
wherein said optical sensor (5) has spectral resolution in the visible spectrum, to acquire images of said loose product irradiated by said electromagnetic visible light radiation.

14. The selector machine of claim 13, wherein said overall continuous spectral band is extended, at least partially, in the interval from 400 nm to 1800 nm.

15. The selector machine of claim 13, wherein each said group (43) of LEDs comprises one or more bright LEDs (45) adapted to generate said electromagnetic visible light radiation.

16. The selector machine of claim 13, wherein said at least hyperspectral camera (51) has spectral range in the visible spectrum to acquire images of said loose product irradiated by said electromagnetic visible light radiation.

17. The selector machine of claim 1, wherein said conveyance system (2) comprises at least one slide (12) placed along said advancement path (A) upstream of said analysis section (A′) and susceptible of being crossed by said loose product and of discharging said loose product via falling along said analysis section (A′).

18. The selector machine of claim 1, further comprising a support frame (17), which carries, mounted thereon, said conveyance system (2) and internally defines an operative volume (18) at least partially crossed by said advancement path (A) and in which said optical detection system (3) is placed.

19. The selector machine of claim 17, further comprising a support frame (17), which carries, mounted thereon, said conveyance system (2) and internally defines an operative volume (18) at least partially crossed by said advancement path (A) and in which said optical detection system (3) is placed;
wherein said slide (12) is placed within said operative volume (18).
